(19) United States
(12) Patent Application Publication
(10) Pub. No.: US 2013/0286216 A1
(43) Pub. Date: Oct. 31, 2013

(54) Rifle Scope Including a Circuit Configured to Track a Target

(71) Applicants: John Hancock Lupher, Austin, TX (US); John Francis McHale, Austin, TX (US); Douglas Ainsworth Scott, Cedar Park, TX (US)

(72) Inventors: John Hancock Lupher, Austin, TX (US); John Francis McHale, Austin, TX (US); Douglas Ainsworth Scott, Cedar Park, TX (US)

(73) Assignee: TRACKINGPOINT, INC., Austin, TX (US)

(21) Appl. No.: 13/460,825

(22) Filed: Apr. 30, 2012

(51) Int. Cl. H04N 5/225

(52) U.S. Cl. 348/169; 348/E05.024

(57) ABSTRACT

A rifle scope includes at least one optical sensor configured to capture a video of a view area, a display, a processor coupled to the display and to the at least one optical sensor, and a memory accessible to the processor. The memory stores instructions that, when executed, cause the processor to receive user input that identifies a target within the video, apply a visual tag to the target within the video, and adjust the visual tag to track the target within a sequence of frames. The memory further stores instructions that, when executed, cause the processor to provide the video including the visual tag to the display.

### FIELD

The present disclosure is generally related to gun scopes, and more particularly to rifle scopes configured to track a target.

### BACKGROUND

Conventionally, a telescopic device uses lenses to focus light, magnifying at least a portion of a view area in front of the telescope. Jitter (human movements and twitches) are magnified by the telescopic device. Such jitter in combination with the movement of a target within the view area make tracking of the target difficult at almost any level of magnification. Further, once the target leaves the view area, it can be very difficult to reacquire the target again using the telescopic device.

### SUMMARY

In an embodiment, a gun scope includes at least one optical sensor configured to capture a video of a view area, a display, a processor coupled to the display and to the at least one optical sensor, and a memory accessible to the processor. The memory stores instructions that, when executed, cause the processor to receive user input that identifies a target within the video, apply a visual tag to the target within the video, and adjust the visual tag to track the target within a sequence of frames. The memory further stores instructions that, when executed, cause the processor to provide the video including the visual tag to the display.

In another embodiment, a method includes capturing a video using a circuit of a gun scope, receiving a user input at the circuit that identifies a target within the video, and automatically processing the video to track the target, frame-by-frame, within the video. The method further includes providing the video to a display of the gun scope.

In still another embodiment, a circuit includes an input interface configured to receive a sequence of frames of a video corresponding to a view area of a telescopic device, a user interface configured to receive user inputs, and a processor coupled to the input interface and to the user interface. The circuit further includes a memory coupled to the processor. The memory is configured to store instructions that, when executed by the processor, cause the processor to receive a user input to select a target within the video, automatically apply a visual tag to the target in response to receiving the user input, adjust the visual tag, frame-by-frame, to track the target, and provide the video including the visual tag to a display.

### BRIEF DESCRIPTION OF THE DRAWINGS

FIG. 1 is a perspective view of an embodiment of a telescopic device including circuitry configured to track a target.

FIG. 2 is a perspective view of an embodiment of a binocular device including circuitry configured to track a target.

FIG. 3 is a view of an illustrative example of a view area captured through a rifle scope including a visual tag applied to the target within the view area by the circuitry of FIGS. 1 and 2.

FIG. 4 is an illustrative example of the view area of FIG. 3 in which the target has moved and in which the position of the visual tag is adjusted to follow the target using the circuitry of FIGS. 1 and 2.

FIG. 5 is a block diagram of an example of one possible method of tracking a target within a view area using the circuitry of FIGS. 1 and 2.

FIG. 6 is a simplified block diagram of an example of one possible method of identifying a local motion vector for the target.

FIG. 7 is a block diagram of an embodiment of a system including the circuitry of FIGS. 1 and 2.

FIG. 8 is a diagram of an embodiment of a firearm system including a rifle scope having circuitry configured to track a selected target.

FIG. 9 is a flow diagram of an embodiment of a method of tracking a target using a circuit within a telescopic device.

In the following discussion, the same reference numbers are used in the various embodiments to indicate the same or similar elements.

### DETAILED DESCRIPTION OF ILLUSTRATIVE EMBODIMENTS

Embodiments of a telescopic device, circuits and methods are described below that include circuitry configured to process video to track a target. The telescopic device can be a rifle scope, a binocular display device, a spotting scope, or another type of telescopic device. In an example, the circuitry is configured to apply a visual tag to a target in a frame of a video, to detect localized movement of the target relative to visual elements within the video, frame-by-frame, and to adjust a location of the visual element to track the target as it moves within and through the view area. In a particular example, the circuitry includes or is coupled to a display configured to display the video including the visual tag.

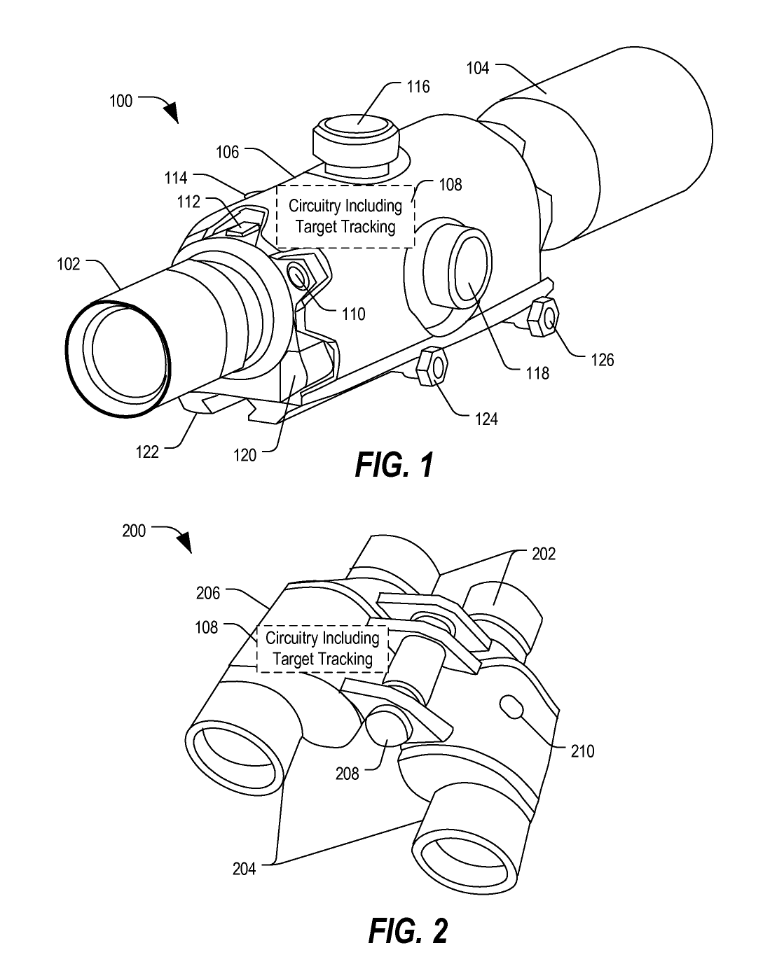

FIG. 1 is a perspective view of an embodiment of a telescopic device 100 including circuitry 108 configured to track a target. Telescopic device 100 includes an eyepiece 102 and an optical element 104 coupled to a housing 106. Housing 106 forms an enclosure sized to receive circuitry 108, which includes target tracking functionality. Optical element 104 includes an objective lens and other components configured to receive light and to direct and focus the light toward optical sensors associated with circuitry 108. Circuitry 108 includes optical sensors for capturing images and/or video of the view area and includes (or is coupled to) a display for displaying images to the user through eyepiece 102.

Telescopic device 100 includes user-selectable buttons 110 and 112 on the outside of housing 106 that allow the user to interact with circuitry 108 to select between operating modes, to adjust settings, and so on. In some instances, the user may interact with at least one of the user-selectable buttons 110 and 112 to select a target within the view area. Further, telescopic device 100 includes thumbscrews 114, 116, and 118, which allow for manual adjustment of the telescopic device 100. In an example, thumbscrews 114, 116 and 118 can be turned, individually, to adjust the crosshairs within a view area of telescopic device 100. In some instances, thumbscrews 114, 116, and 118 can be omitted. Alternatively or in addition, user selectable buttons may be provided on a device or component that can be coupled to the telescopic device 100 (such as through a universal serial bus (USB) interface or wireless interface or through a wired or wireless connection to buttons on a grip of a firearm) to allow the user to interact with circuitry 108 and/or to select a target.

Housing 106 includes a removable battery cover 120, which secures one or more batteries (or other charge storage device) within housing 106 for supplying power to circuitry 108. Housing 106 is coupled to a mounting structure 122, which is configured to mount to a surface using fasteners 124 and 126. In a particular example, mounting structure 122 can be secured to a portable structure, such as a tripod, a rifle, an air gun, or another structure. In some instances, mounting structure 122 may be omitted, and a handle or strap may be provided to assist the user in holding the telescopic device 100 in his/her hand.

Circuitry 108 is configured to capture video of a view area in front of optical element 104. The user may interact with buttons 110 and/or 112 to control selection of a target within the view area in conjunction with the reticle. Circuitry 108 is configured to generate a reticle that is provided within the video provided to the display. Further, circuitry 108 is configured to receive the user input and to generate and apply a visual tag to the selected target. The visual tag may be a square, a circle, an “X”, or some other visual indicator that can be superimposed on the target within the video. Circuitry 108 superimposes the visual indicator on the target in the video and provides the video to the display. Further, circuitry 108 is configured to track the target from frame-to-frame within the video and to adjust the visual tag within the video to stay on the target even as the target moves, independent of the position of the reticle.

While the above-example depicts a telescopic device that could be used as a gun scope, a spotting scope, or a telescope, circuitry 108 may also be incorporated in other optical devices. An example of a binocular device that incorporates circuitry 108 is described below with respect to FIG. 2.

FIG. 2 is a perspective view of an embodiment of a binocular device 200 including circuitry configured to track a target. In this instance, binocular display device 200 includes eyepieces 202 and optical elements 204 coupled through a housing 206 that may include one or more prismatic components as well as circuitry 108. Housing 206 also includes a display coupled to circuitry 108 for presenting visual images of a view area and including a visual tag superimposed on a selected target within the view area. Binocular device 200 includes a user-selectable button 210, which the user can access to select the target. Additionally, binocular display device 200 further includes a binocular adjustment mechanism 208 allowing for physical adjustment of the eyepieces 202 to fit the user.

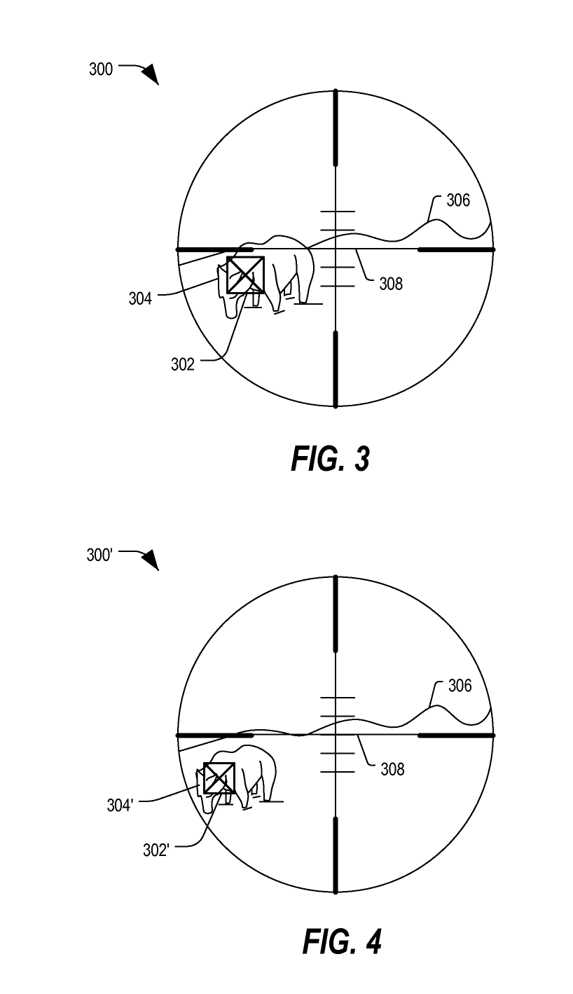

In this example, circuitry 108 includes optical sensors configured to capture video associated with a view area that is observed through at least one of the optical elements 204. Circuitry 108 aligns visual elements within a frame to corresponding visual elements within a previous frame, frame-by-frame, stabilizing visual background elements within the sequence of frames and tracks the selected target whether it remains stationary or moves from frame-to-frame. Circuitry 108 places a visual tag on the target to visually track the target. Examples of the view area showing a target and a visual tag are described below with respect to FIGS. 3 and 4.

FIG. 3 is a view of an illustrative example of a view area 300 captured through a rifle scope including a visual tag 302 applied to the target 304 within the view area by the circuitry 108 of FIGS. 1 and 2. The view area 300 includes a background 306 with target 304 in the foreground. Circuitry 108 generates and provides a reticle 308, which is superimposed on the view area together with visual tag 302. As the target 304 moves, circuitry 108 adjusts the location of visual tag 302, from frame-to-frame, so that the visual tag appears to move with target 304.

FIG. 4 is an illustrative example of a view area 300′, which is the view area 300 of FIG. 3 with the target having moved. In this instance, the apostrophe is used to differentiate the changed elements within the display. In this instance, the reticle 308 and background 306 remain unchanged, but target 304′ has moved relative to target 304, and visual tag 302′ has moved with target 304′.

In the above-discussion, it is assumed that the target 304 has moved. In one example, prior to application of the tag or visual marker to the target, the reticle is a view reticle that is centered within the view area of the scope. Upon selection of the target, the reticle can become a ballistics reticle that is aligned to the instantaneous impact location of the shot if it were taken at that instant. In particular, in response to selection of the target, circuitry 108 can calculate the impact location of the shot based on range information, ballistic information, orientation of the rifle, and so on. The resulting impact location can then be reflected by a ballistics reticle, which corresponds to the calculated impact location. In some instances, circuitry 108 may cause the view area to scroll until the reticle is centered on the calculated impact location. In other instances, circuitry 108 may display an indicator to direct the user to adjust the orientation of the rifle, for example, to realign the ballistics reticle to the previously selected target. In general, the ballistics reticle will reflect, for example, temperature, wind, elevation, range, bullet drop, and other factors that can affect the trajectory of the bullet.

While the views 300 and 300′ in FIGS. 3 and 4 are described as being taken from a rifle scope, it should be appreciated that the same or similar views could be captured from any number of telescopic devices, including binoculars, spotting scopes, telescopes, or other optical devices. Further, in each case, the optical sensors are configured to capture optical data from a wider area than that shown on the display, allowing circuit 108 to track a selected target even after the target moves out of the view area. In one instance, circuitry 108 continues to display the target 304 with visual tag 302 and shifts the reticle or an indicator related to the relative position of the reticle within the view area to indicate that the target has moved relative to the direction of aim of the telescopic device. The indicator can include a pointer to direct the user to adjust the aim of the telescopic device 100 or 200 in order to align reticle 308 to the target 304.

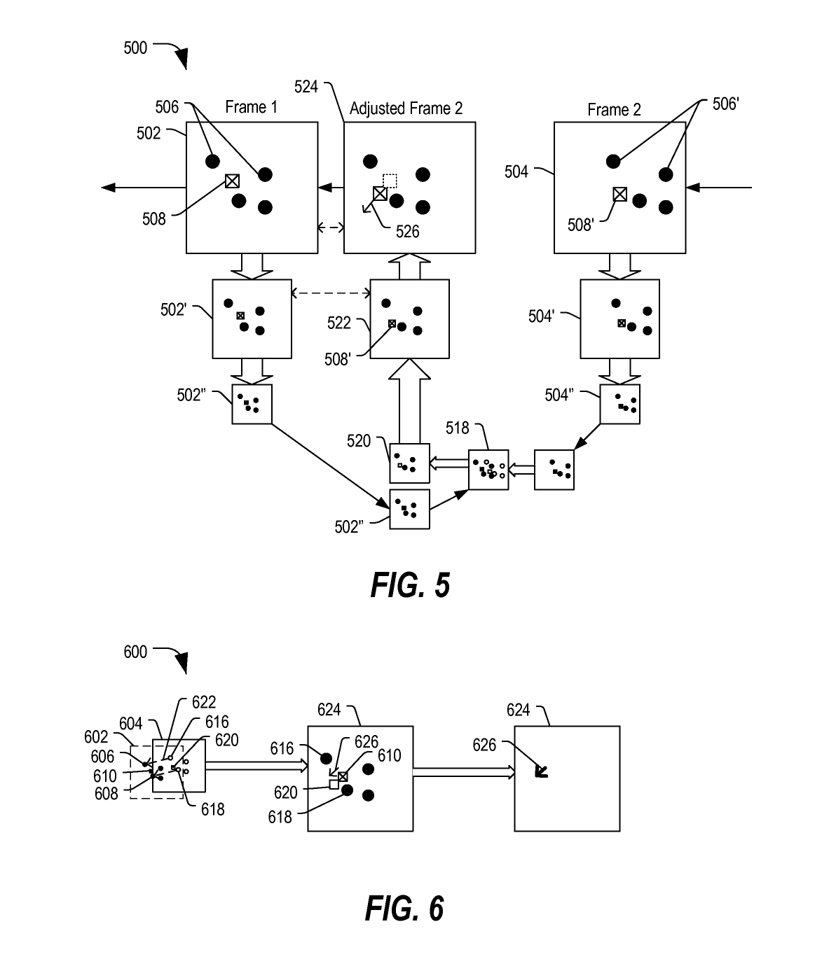

FIG. 5 is a block diagram of an example of one possible method 500 of tracking a target within a view area using the circuitry 108 of FIGS. 1 and 2. In FIG. 5, circuitry 108 receives a sequence of video frames, such as frames 502 and 504. Circuitry 108 identifies visual elements 506 within frame 502. Additionally, circuitry 108 receives data related to a target 508. In an example, the data is user input received from user interaction with one of the buttons 110 and 112 (in FIG. 1). Circuitry 108 compresses frame 502 through a first compression operation to produce a compressed frame 502′ having compressed visual elements. Circuitry 108 further compresses frame 502′ through one or more second compression operations to produce compressed frame 502″ having compressed visual elements.

Circuitry 108 receives a second frame 504 including visual elements 506′, which are shifted relative to optical elements 506 in previous frame 502. Circuitry 108 compresses the second frame 504 through a compression operation to produce a compressed frame 504′ having compressed visual elements. Circuitry 108 further compresses the compressed frame 504′ through one or more compression operations to produce compressed frame 504″ having compressed visual elements.

As shown in frame 518, when the visual elements from compressed frames 502″ and 504″ are combined, the relative positions of visual elements 506 and 506′ within their respective frames are shifted, which shift may be caused by movement of the telescopic device 100 by the user. However, the visual elements 506 and 506′ represent background objects that have not moved relative to one another within their respective frames 502 and 504. Frame 518 depicts the relative positions of the visual elements 506 and 506′ as if frames 502″ and 504″ were combined. Circuitry 108 aligns visual elements 506 and 506′ as depicted in frame 520 to determine alignment information. However, it should be noted that target 508′ has moved relative to the other visual elements 506′ and relative to target 508 in frame 502. Circuitry 108 uses the alignment information determined from frame 520 and further refines it with respect to visual elements within frame 522 relative to frame 502′. Circuitry 108 uses the refined alignment information from frame 522 to align visual elements elements with those within frame 502, and further refines that alignment information to produce an adjusted frame 524, which can be presented to a display device as a second frame in a sequence of frames, providing frame-to-frame video stabilization. Further, the relative movement of target 508′ can be calculated as a motion vector, as generally indicated by arrow 526.

By aligning visual elements 506 and 506′ from frame-to-frame, circuitry 108 stabilizes the images to reduce or eliminate jitter. Further, by utilizing compression, pixel alignment can be performed at various levels of compression (various levels of granularity) to produce aligned frames at a desired level of resolution. Additionally, localized movement of one or more visual elements (particularly a selected target) can be detected by circuitry 108 and can be used to reposition or relocate the visual tag to track the selected target from frame-to-frame.

In the example of FIG. 5, circuitry 108 compresses the frame twice and then aligns the visual (optical) elements at each level of compression, refining the alignment information at each compression level to produce the adjusted frame. While two compression operations are described, it should be appreciated that multiple compression operations may be performed to provide a desired level of granularity with respect to the pixel adjustments as part of the video stabilization process. In an example, each level of compression provides a courser level of granularity in terms of image alignment, pixel-wise. As the alignment process proceeds, the pixel-wise alignment is refined at each stage, allowing the received frame to be aligned to the previously received frame to a desired level of granularity. At each compression level, the pixels of a given frame may be adjusted slightly to correct for the higher resolution, thereby enhancing alignment precision. In an alternative example, alignment of the visual elements may be performed without compression.

While the example of FIG. 5 depicts a representative example of a method of compressing, aligning, and iterative adjustment of adjacent frames in a sequence of frames of a video to stabilize the video, localized motion within the stabilized video can also be determined. An example depicting determination of a localized motion vector based on adjacent frames is described below with respect to FIG. 6.

FIG. 6 is a simplified block diagram of an example of one possible method 600 of identifying a local motion vector for the target. In method 600, frame 602 includes visual elements 606 and 608 and target 610. Frame 604 includes visual elements 616 and 618 and target 620. Visual elements 606 and 616 and visual elements 608 and 618 are aligned by an alignment vector 622 to produce an adjusted frame 624, which represents frame 604 having visual elements 616 and 618, which are aligned to the frame position of visual elements 606 and 608. However, target 620 is in a different location relative to visual elements 616 and 618 and relative to target 610 in frame 602. The change in position of target 620 relative to the target 610 defines a motion vector 626.

The motion vector 626 can be used to adjust the location of the visual tag so that the visual tag tracks the movement of the target from frame-to-frame. Further, the circuitry 108 utilizes the differences between the alignment vector 622 and the motion vector 626 to differentiate between the background and the target.

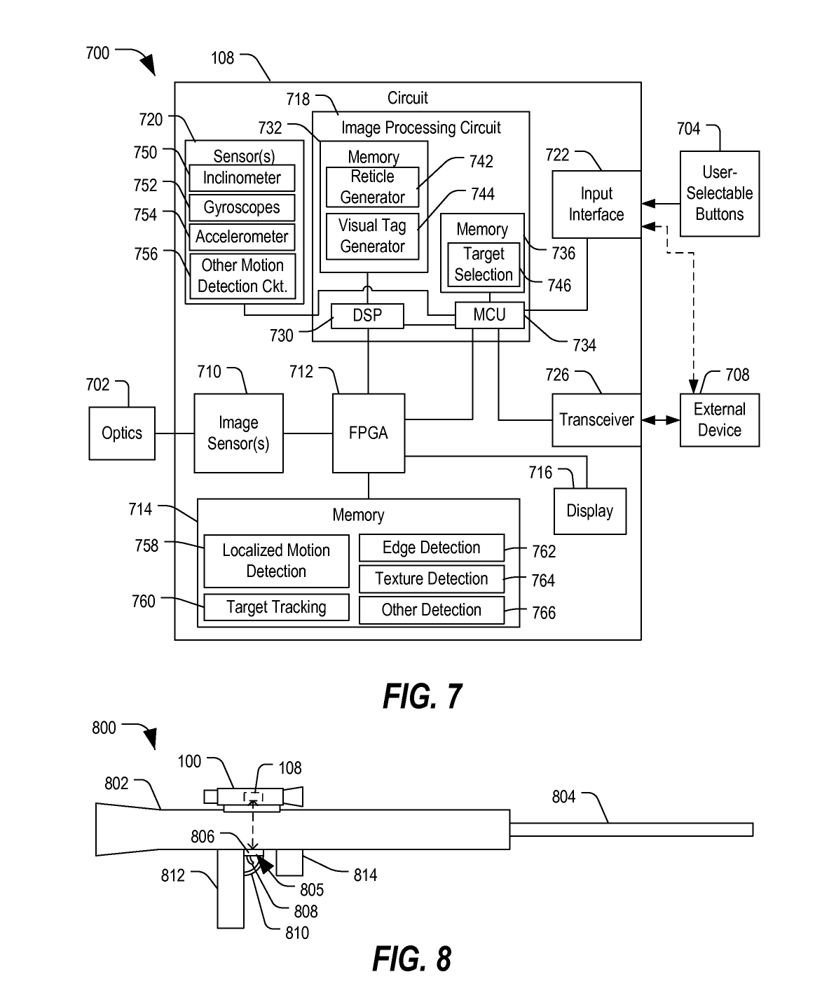

While the above-description has described one possible method of tracking a target within a view area, other methods may also be used. One possible example of a circuit configured to track a target within a view area is described below with respect to FIG. 7.

FIG. 7 is a block diagram of an embodiment of a system 700 including the circuit 108 of FIGS. 1 and 2. System 700 includes optical elements 702 configured to direct (and focus) light toward image (optical) sensors 710 of circuitry 108. System 700 further includes user-selectable buttons 704 (such as buttons 110 and 112 and/or thumb screws 114, 116, and 118 in FIG. 1) coupled to an input interface 722 of circuitry 108 to allow the user to interact with circuitry 108, for example, to select options and/or to make adjustments. In some instances, user-selectable buttons 704 can be implemented on an external device, such as external device 708, which can be coupled to circuitry 108, through an input interface 722 or through a transceiver 726. In an example, external device 708 can be a smart phone, a tablet computer, a laptop, or another computing device.

Circuitry 108 includes a field programmable gate array (FPGA) 712 including one or more inputs coupled to outputs of image (optical) sensors 710. FPGA 712 further includes an input/output interface coupled to a memory 714, which stores data and instructions. FPGA 712 includes a first output coupled to a display 716 for displaying video and/or text. FPGA 712 is also coupled to a digital signal processor (DSP) 730 and a micro-controller unit (MCU) 734 of an image processing circuit 718. DSP 730 is coupled to a memory 732 and to MCU 734. MCU 734 is coupled to a memory 736. Memories 714, 732, and 736 are computer-readable and/or processor-readable data storage media capable of storing instructions that are executable (by FPGA 712, DSP 730, and/or MCU 734, respectively) to perform various operations.

Circuitry 108 also includes sensors 720 configured to measure one or more environmental parameters (such as wind speed and direction, humidity, temperature, and other environmental parameters), to measure motion of the telescopic device, and/or to measure optical elements, such as reflected laser range finding data, and to provide the measurement data to MCU 734. In one example, sensors 720 include inclinometers 750, gyroscopes 752, accelerometers 754, and other motion detection circuitry 756.

FPGA 712 is configured to process image data from image (optical) sensors 710. FPGA 712 processes the image data to stabilize the video by aligning adjacent frames. Further FPGA 712 enhances image quality through digital focusing and gain control. In some instances, FPGA 712 also performs image registration and cooperates with DSP 730 to perform visual target tracking FPGA 712 further cooperates with MCU 734 to mix the video data with reticle information and provides the resulting video data to display 716.

While the example of FIG. 7 depicted some components of circuitry 108, at least some of the operations of circuitry 108 may be controlled using programmable instructions. MCU 734 is coupled to input interface 722 and network transceiver 726. In an example, circuitry 108 can include an additional transceiver, which can be part of an input interface 722, such as a Universal Serial Bus (USB) interface or another wired interface for communicating data to and receiving data from a peripheral circuit. In an example, MCU 734, DSP 730, and FPGA 712 may execute instructions stored in memories 736, 732, and 714, respectively. Network transceiver 726 and/or input interface 722 can be used to update such instructions. For example, the user may couple circuit 108 to an external device 708 (such as a smart phone, server, portable memory device, laptop, tablet computer, military radio, or other instruction storage device) through a network (not shown) or through a wired connection (such as through a USB connection) to download updated instructions, such as target tracking instructions, which can be stored in one or more of the memories 714, 732, and 736 to upgrade the operation of circuit 108. In one instance, the replacement instructions may be downloaded to a portable storage device, such as a thumb drive, which may then be coupled to circuitry 108. The user may then select and execute the upgrade instructions by interacting with the user-selectable elements 704.

In the illustrated example, memory 732 stores reticle generator instructions 742 that, when executed by DSP 730, cause DSP 730 to generate a reticle that can be superimposed or otherwise provided within a view area of the video stream. Further, memory 732 stores visual tag generator instructions 744 that, when executed, cause DSP 730 to generate a visual tag that can be applied to a selected target within the view area.

Further, memory 736 stores target selection instructions 746 that, when executed cause MCU 734 to receive user input corresponding to selection of a target within the video stream. Further, when executed, target selection instructions 746 cause MCU 734 to communicate target selection information to the FPGA 712 and to DSP 730 for use in processing the video.

Memory 714 stores localized motion detection instructions 758 that, when executed, cause FPGA 712 to determine a local motion vector for a selected target, and target tracking instructions 760 that, when executed, cause FPGA 712 to track a target from frame-to-frame within the video and to move the visual tag or marker to visually track the target within the video. Memory 714 also stores edge detection instructions 762 that, when executed, cause FPGA 712 to detect edges of a selected target to disambiguate a selected target from background portions of the video. Memory 714 further stores texture detection instruction 764 that, when executed, cause FPGA 712 to use texture within the frame to differentiate or isolate a target. Memory 714 may also include other detection instructions 766 that, when executed, cause FPGA 712 to differentiate between background and target information through some other algorithm or data point. In some instances, memory 714 may include algorithm selection instructions that, when executed, cause FPGA 712 to select one or more algorithms to detect the target. In one instance, such instructions cause FPGA 712 to apply multiple algorithms. In another instance, such instructions cause FPGA 712 to select algorithms having higher selectivity in low-contrast environments (for example, to enhance target acquisition and tracking) and lower-selectivity in high contrast environments (for example, to conserve power).

Circuitry 108 is configured to initially stabilize the entire view area. In high contrast environments, circuitry 108 may utilize edge detection algorithms to automatically differentiate a selected target from background aspects of the view area. Alternatively, circuitry 108 may attempt to identify contrasts or color changes relative to the target selected by the user input to attempt to detect an outline or edge of a potential target. If the object is moving, relative movement may be used to automatically detect or to refine detection of the selected target. In some instances, texture detection or other types of optical detection (or a combination of detection algorithms, infrared input, light detection and ranging (LIDAR), acoustic detection, and data from other types of sensors) can be used to isolate a potential target from the stabilized background. In an example, texture of an image can be analyzed as a function of the spectral content of the pixels after application of one or more filters.

To define the texture content of a target, circuitry 108 can be configured to construct an energy vector for the target within the view area. A camouflaged target within a view area can present a different texture than surrounding or neighboring pixel areas, making it possible to identify a camouflaged target within the view area even when little light contrast is available. Once the target is identified by the user, circuitry 108 can track the target over time. In a first example where the target is moving within the view area, the changes in the pixel area over time can be used to track the selected target.

As the user orients the telescopic device 100 to change the view area, telescopic device 100 captures neighboring view areas, and circuitry 108 calculates texture similarities in order to stitch together adjacent view areas as part of a smoothing function to align adjacent frames to smooth out the view area. When the optical view area is changed, one possible way to reacquire a target in a current view area includes searching neighboring regions for a pixel intensity distribution similar to the selected target and can include minimizing a distance between the target pixel distribution and that of the candidate target area. However, due to low contrast of the target relative to the background, the update may not necessarily occur when the target is correctly localized. To enhance target acquisition, circuitry 108 updates the shape/outline/model of the selected target when the correlation of the identified model with the selected object exceeds a threshold. In other words, when movement of the selected target and/or the background contrast provides sufficient information to enhance the model of the selected target, circuitry 108 can enhance the selected target information with the additional information.

In a particular example, as the target moves within the view area and continues outside of the original view area, the user may adjust the orientation of the telescopic device 104 to follow the target. In response to such movement, the view area will shift, and circuitry 108 operates to smooth the movement on the display to provide a relatively seamless display image, continuing to provide the visual marker or tag on the previously selected target.

The above examples can be used with any telescopic device, including, but not limited to, telescopes, rifle scopes, spotting scopes, binoculars, microscopes, and the like. An example of telescopic device in conjunction with a rifle is described below with respect to FIG. 8.

FIG. 8 is a diagram of an embodiment of a firearm system 800 including telescopic device 100 of FIG. 1 configured as a rifle scope and having circuitry 108 configured to track a selected target. Telescopic device 100 is mounted to a rifle 802 and aligned with a muzzle 804 of rifle 802 to capture a view area in the target direction. Rifle 802 includes a trigger assembly 806 including a peripheral circuit 805, which may include sensors and actuators for monitoring and controlling discharge of the firearm system 800. Rifle 802 further includes a trigger shoe 808 to which a user may apply a force to discharge rifle 802. Rifle 802 further includes a trigger guard 810 and a grip 812 as well as a magazine 814. In this example, circuitry 108 within telescopic device 100 stabilizes a display of the view area and tracks selected targets to assist the user in directing the projectile from the firearm system 800 toward a selected target.

In this example, circuitry 108 allows the user to select a target and automatically tracks the target, over time, assisting the user to continue to view the target and/or engage or shoot the target being tracked. Further, circuitry 108 can include logic configured to determine the orientation and motion of rifle 802 relative to a selected target and to prevent discharge until the rifle 802 is aligned to the target within an acceptable margin of error.

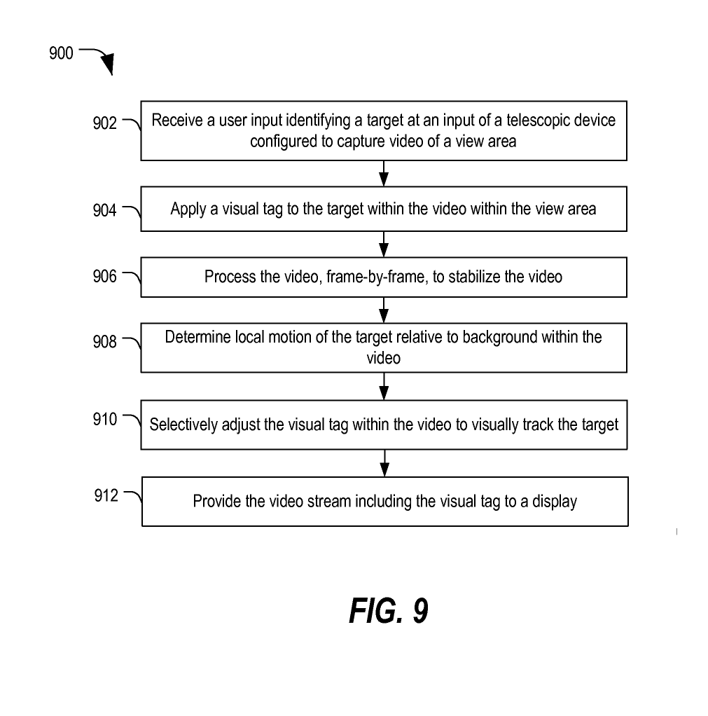

Circuitry 108 is configured to track a selected target within a view area in response to user selection of the target. One possible example of a method of tracking the selected target is described below with respect to FIG. 9.

FIG. 9 is a flow diagram of an embodiment of a method 900 of tracking a target using a circuit within a telescopic device. At 902, circuit 108 receives a user input identifying a target at an input of a telescopic device configured to capture video of a view area. The user input can be received through one or more buttons coupled to the circuit or from an external device that is coupled to or configured to communicate with the circuit 108. Advancing to 904, circuit 108 applies a visual tag to the target within the video in response to receiving the user input. Continuing to 906, circuit 108 processes the video, frame-by-frame, to stabilize the video relative to the selected target.

Continuing to 908, circuit 108 determines local motion of the target relative to a background within the video. Proceeding to 910, circuit 108 selectively adjusts a position of the visual tag within the video to visually track the target in the view area. In an example, the visual tag is presented as if it were physically attached to the target as the target moves. Moving to 912, circuit 108 provides the video stream, including the visual tag, to a display.

It should be understood that the method 900 in FIG. 9 is one of many possible methods of tracking a target. For example, block 908 may be replaced or supplemented with contrast detection, texture detection, edge detection, or other target detection operations to assist circuit 108 in isolating a selected target and in tracking the selected target from frame-to-frame. Additionally, local motion of a particular target may be determined without providing image stabilization.

In conjunction with the systems, circuits, and methods described above with respect to FIGS. 1-9, a telescopic device includes a circuit configured to capture a video, to receive a user input to select a target within the video, and, in response to the user input, to track the target from frame-to-frame within the video. In some instances, the circuit is configured to apply a visual tag to the selected target and to adjust the position of the visual tag within the video to track movement of the selected target.

Although the present invention has been described with reference to preferred embodiments, workers skilled in the art will recognize that changes may be made in form and detail without departing from the scope of the invention.

What is claimed is:

1. A rifle scope comprising:
at least one optical sensor configured to capture a video of a view area;
a display;
a processor coupled to the display and to the at least one optical sensor; and
a memory accessible to the processor, the memory to store instructions that, when executed, cause the processor to:
receive user input identifying a target within the video;
apply a visual tag to the target within the video;
adjust the visual tag to track the target within a sequence of frames; and
provide the video including the visual tag to the display.

2. The rifle scope of claim 1, wherein the memory stores instructions that, when executed, cause the processor to determine a motion vector of the target relative to visual elements within adjacent frames of the sequence of frames.

3. The rifle scope of claim 1, further comprising:
a user selectable input accessible by a user to select a target within the video; and
wherein the memory stores instructions that, when executed, cause the processor to differentiate the target from background information in the video.

4. The rifle scope of claim 3, wherein the memory stores instructions that, when executed, cause the processor to detect one or more edges of the target.

5. The rifle scope of claim 3, wherein the memory stores instructions that, when executed, cause the processor to detect textures within the video and to detect the target based on the textures.

6. The rifle scope of claim 1, further comprising:
optics configured to focus light from a view area toward the at least one optical sensor; and
wherein the memory stores instructions that, when executed, cause the processor to display a magnified view of a portion of the view area corresponding to one of a target area aligned with a center of the optics and a second area including the target that is outside of the target area.

7. The rifle scope of claim 1, wherein the memory includes instructions that, when executed, cause the processor to utilize one or more of an edge detection process, a contrast detection process, and a texture detection process to isolate the target from the background in relatively low contrast environments and to utilize the contrast detection process in relatively high contrast environments.

8. A method comprising:
capturing a video using a circuit of a rifle scope;
receiving a user input at the circuit that identifies a target within the video;
automatically processing the video to track the target, frame-by-frame, within the video; and
providing the video to a display of the rifle scope.

9. The method of claim 8, further comprising:
applying a visual tag to the target within the video; and
adjusting a position of the visual tag, frame-by-frame, based on a position of the target within the video to position the visual tag onto the target.

10. The method of claim 8, further comprising applying at least one of an edge detection operation, a contrast detection operation, and a texture detection operation on a portion of a frame of the video including the target to isolate the target in response to receiving the user input.

11. The method of claim 10, further comprising:
receiving motion information from at least one motion sensor; and
selectively adjusting tracking information about the target based on the motion information.

12. The method of claim 8, wherein automatically processing the video to track the target comprises:
selecting a relative high sensitivity detection algorithm for processing low-contrast video; and
selecting a relatively low sensitivity detection algorithm for processing high-contrast video.

13. The method of claim 8, wherein receiving the user input at the circuit includes receiving a signal corresponding to user interaction with a button coupled to the circuit.

14. A circuit comprising:
an input interface configured to receive a sequence of frames of a video corresponding to a view area of a rifle scope;
a user interface configured to receive user inputs;
a processor coupled to the input interface and to the user interface; and
a memory coupled to the processor, the memory configured to store instructions that, when executed by the processor, cause the processor to:
receive a user input to select a target within the video;
automatically apply a visual tag to the target in response to receiving the user input;
adjust the visual tag, frame-by-frame, to track the target; and
provide the video including the visual tag to an output.

15. The circuit of claim 14, further comprising at least one optical sensor coupled to the input interface.

16. The circuit of claim 14, wherein the user interface comprises at least one of a button and a universal serial bus interface for receiving a user input.

17. The circuit of claim 14, wherein the memory is further configured to store instructions that, when executed, cause the processor to:
apply at least one of an edge detection operation, a contrast detection operation, and a texture detection operation on the portion of the frame to isolate the target in response to receiving the user input; and
select between one or more of the operations based on a level of contrast within the video.

18. The circuit of claim 14, wherein the output comprises a display interface coupled to the processor and configurable to couple to a display device, the display interface configured to provide one of the video and a processed version of the video to the display interface.

19. The circuit of claim 14, wherein:
the visual tag comprises a geometric shape; and
the processor automatically applies the visual tag by superimposing the geometric shape on the target.

20. The circuit of claim 14, wherein the circuit is configured for use within the rifle scope comprising at least one of a telescope, a binocular device, a rifle scope, and a spotting scope.
